(19) United States
(12) Patent Application Publication
(10) Pub. No.: US 2021/0177698 A1
(43) Pub. Date: Jun. 17, 2021

(54) PILL CONTAINER

(71) Applicant: E-LINK PLASTIC & METAL INDUSTRIAL CO., LTD., New Taipei City (TW)

(72) Inventor: Cheng-Hua LEE, New Taipei City (TW)

(21) Appl. No.: 16/713,057

(22) Filed: Dec. 13, 2019

(51) Int. Cl. A61J 1/03; A61J 7/00

(52) U.S. Cl. CPC A61J 1/03; A61J 7/0069; A61J 7/0084

(57) ABSTRACT

A pill container has at least one pair of compartment units. Each pair of compartment units has two compartment units and a connection portion being hollow and mounted between the compartment units to connect the two compartment units with each other. Each compartment unit has a compartment, a locking button, a lid, and a resilient pushing bar. The compartment is hollow and has a front wall and a rear wall connected with the connection portion. The locking button is formed on the front wall of the compartment. The lid is pivotally connected with the rear wall of the compartment to selectively close the compartment, is engaged detachably with the locking button, and has an inner surface facing the compartment. The resilient pushing bar is mounted in the connection portion, extends over the rear wall of the compartment, and abuts against the inner surface of the lid.

### BACKGROUND OF THE INVENTION

### 1. Field of the Invention

The present invention relates to a pill container, and more particularly to a lockable pill container.

### 2. Description of Related Art

A pill container is applied to hold pills, such as medicines or vitamins for a user to take pills regularly. A conventional pill container, such as U.S. Pat. No. 10,420,703, substantially comprises a body, multiple lids, and multiple resilient pushing bars. The body has multiple compartments formed in the body for holding pills inside. The lids are pivotally connected with the body to close the compartments. The resilient pushing bars are mounted on a rear wall of the body and respectively abut against inner surfaces of the lids to automatically push the lids to open.

However, because the resilient pushing bars of the pill container of the '703 Patent are mounted on the rear walls of the body, the compartments of the body can only be arranged in a single row and cannot be arranged in two parallel rows. Therefore, the structure of the body of the pill container of the '703 Patent is limited and is not versatile in use.

To overcome the shortcomings, the present invention tends to provide a pill container to mitigate or obviate the aforementioned problems.

### SUMMARY OF THE INVENTION

The main objective of the invention is to provide a pill container to allow compartments of the pill container to be arranged in multiple rows.

The pill container has at least one pair of compartment units. Each pair of the at least one pair of compartment units has two compartment units and a connection portion being hollow and mounted between the compartment units to connect the two compartment units with each other. Each compartment unit has a compartment, a locking button, a lid, and a resilient pushing bar. The compartment is hollow and has a front wall and a rear wall connected with the connection portion. The locking button is formed on the front wall of the compartment. The lid is pivotally connected with the rear wall of the compartment to selectively close the compartment, is engaged detachably with the locking button, and has an inner surface facing the compartment. The resilient pushing bar is mounted in the connection portion, extends over the rear wall of the compartment, and abuts against the inner surface of the lid.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a pill container in accordance with the present invention;

FIG. 2 is an exploded perspective view of the pill container in FIG. 1;

FIG. 3 is a cross sectional side view of the pill container in FIG. 1; and

FIG. 4 is a perspective view of a second embodiment of a pill container in accordance with the present invention.

### DETAILED DESCRIPTION OF PREFERRED EMBODIMENT

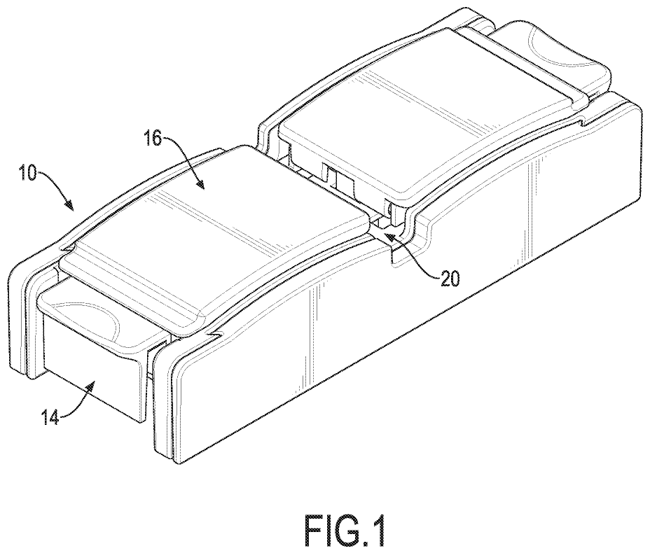

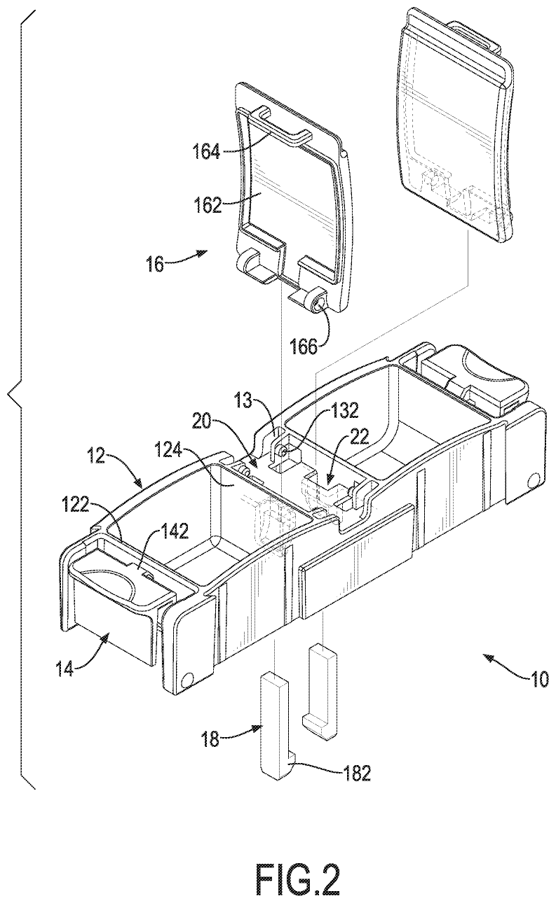

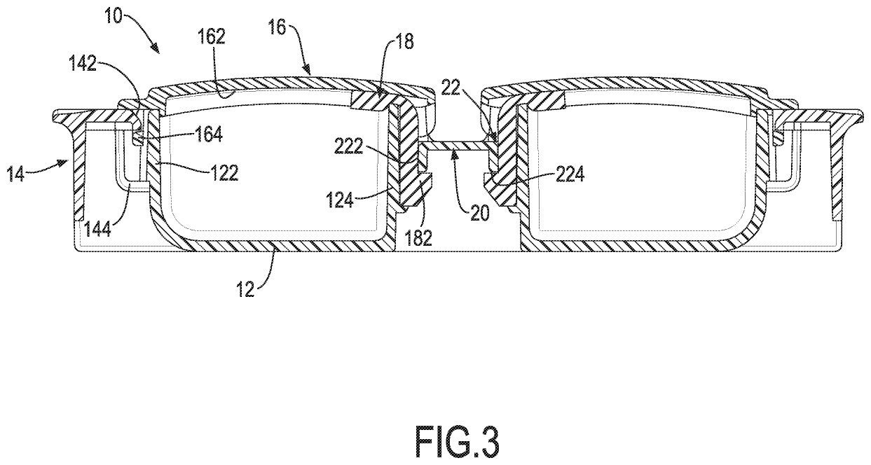

With reference to FIGS. 1 to 3, a pill container in accordance with the present invention comprises at least one pair of compartment units 10. Each pair of compartment units comprises two compartment units 10 and a connection portion 20 mounted between the compartment units to connect the two compartment units with each other. In the first embodiment, one pair of compartment units is implemented. The connection portion 20 is hollow and has an open bottom end. Each compartment unit comprises a compartment 12, a locking button 14, a lid 16, and a resilient pushing bar 18.

The compartment 12 is hollow and has a front wall 122 and a rear wall 124. The compartments 12 are defined in the compartment unit 10 to hold pills inside. The locking button 14 is formed on the front wall 122 of the compartment 12 and has a connecting segment 144 formed on a bottom end of the locking button 14 and connected integrally with the front wall 122 of the compartment 12 to define a gap between the front wall 122 and the locking button 14. In addition, each locking button 14 has a locking block 142 formed on and protruding from the locking button 14. The locking block 142 extends into the gap between the front wall 122 and the locking button 14.

The lid 16 is connected pivotally to the rear wall 124 of the compartment 12 to selectively close the compartment 12 and is engaged detachably with the locking button 14. The lid 16 has an inner surface 162 and a locking loop 164. The inner surface 162 faces the compartment 12. The locking loop 164 is formed on and protrudes from the inner surface 162 of the lid 16 at an end of the lid 16 opposite the rear wall 124 of the compartment 12 to selectively engage with the locking block 142 on the locking button 14.

To pivotally connect each lid 16 to the rear wall 124 of the compartment 12, the compartment 12 further has a pair of pivotal tabs 13 formed on the rear wall 14 of the compartment 12. The pair of pivotal tabs 13 includes two pivotal tabs 13 being parallel with each other. Each pivotal tab 13 has a pivotal axle 132 formed on and protruding from the pivotal tab 13 and aligned with the pivotal axle 132 on the other pivotal tab 13. The lid 16 has two pivotal holes 166 defined in the lid 16 and located around the pivotal axles 132 on the pivotal tabs 13 on the compartment 12. Accordingly, the lid 16 can be pivoted relative to and detached from the rear wall 124 of the compartment 12.

The resilient pushing bar 18 is mounted in the connection portion 20, extends over the rear wall 124 of the compartment 12 and abuts against the inner surface 162 of the lid 16. Preferably, the pushing bar 18 is made of silicone. In addition, the connection portion 20 has two ends and two inserting holes. The ends of the connection portion 20 are connected respectively with the two compartment units 10. The inserting holes 22 are defined respectively in the two ends of the connection portion 20. Each inserting hole 22 has a top opening 222 and a bottom opening 224. The top opening 222 is formed at a top end of the inserting hole 22, and the bottom opening 224 is formed at a bottom end of the inserting hole 22. The resilient pushing bar 18 has a top end and a bottom end. The top end of the resilient pushing bar 18 is inserted into the connection portion 20 via the open bottom end of the connection portion 20, is inserted into one of the inserting holes 22 in the connection portion 20 via the bottom opening 224, extends out of the inserting hole 22 from the top opening 222 of the inserting hole 22, and extends into the compartment 12. The bottom end of the resilient pushing bar 18 is provided with a hook 182 engaged with an edge of the bottom opening 224 of the inserting hole 22. With the engagement between the hook 182 and the edge of the bottom opening 224, the resilient pushing bar 18 can be held securely in place in the inserting hole 22.

With such a pill container, pills, such as medicines or vitamins, can be stored in the compartments 12 to allow a user to take the pills in an organized manner. With the engagement between the locking blocks 142 on the locking buttons 14 with the locking loops 164 on the lids 16, the lids 20 can be held at a closed position. At the closed position, the locking loop 24 on each lid 20 extends into the gap between the front wall 122 of the compartment 12 and the locking button 14, and the resilient pushing bar 18 is pushed against by the inner surface 162 of the lid 16 and is bent.

To open any one of the lids 16, a corresponding locking button 14 is pushed. When the locking button 14 is pushed, the locking block 142 on the locking button 14 is disengaged from the locking loop 164 on the lid 16, and the lid 16 will be automatically pivoted relative to the rear wall 124 of the compartment 12 by the resilient force provided by the bent pushing bar 18. Accordingly, the resilient pushing bar 18 can provide the lid 16 with a sufficient force to completely open the lid 16 relative to the rear wall 124 of the compartment 12. Thus, a user can take the pills contained in the compartment 12 easily and conveniently. Additionally, the lid 16 can be kept from being deformed or bent at the closed position, such that the lid 16 is not prone to damage after a long time of use.

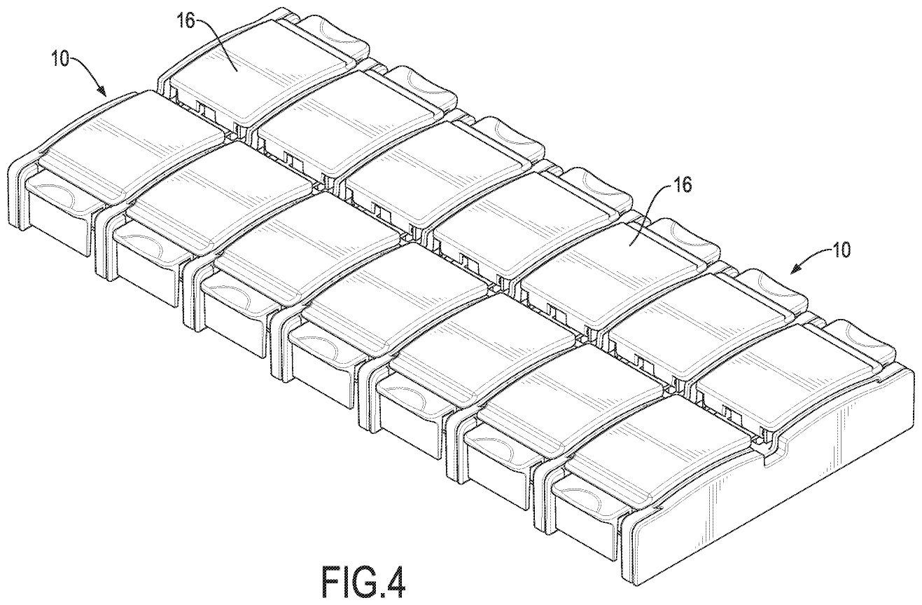

With reference to FIG. 4, in the second embodiment, the pill container in accordance with the present invention comprises multiple pairs of compartment units 10 arranged in a row. The compartments 12 of each pair of compartment units 10 are connected with the compartments 12 of an adjacent pair of compartment units 10. With such an arrangement, multiple compartments 12 can be arranged in two parallel rows, such that the pill container in accordance with the present invention is convenient and versatile in use.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A pill container comprising:
at least one pair of compartment units, each pair of the at least one pair of compartment units comprising two compartment units and a connection portion being hollow and mounted between the compartment units to connect the two compartment units with each other, and each compartment unit comprising
a hollow compartment having a front wall and a rear wall connected with the connection portion;
a locking button formed on the front wall of the compartment;
a lid pivotally connected with the rear wall of the compartment to selectively close the compartment, engaged detachably with the locking button, and having an inner surface facing the compartment; and
a resilient pushing bar mounted in the connection portion, extending over the rear wall of the compartment, and abutting against the inner surface of the lid.

2. The pill container as claimed in claim 1, wherein
the connection portion of each one of the at least one pair of compartment units comprises
two ends connected respectively with the two compartment units of the pair of the compartment units; and
two inserting holes defined respectively in the two ends of the connection portion, and each inserting hole has a top opening formed at a top end of the inserting hole and a bottom opening formed at a bottom end of the inserting hole; and
the resilient pushing bar of each compartment unit has
a top end inserted into one of the inserting holes in the corresponding connection portion via the bottom opening of the inserting hole, extending out of the inserting hole from the top opening of the inserting hole, and extending into the compartment of the compartment unit; and
a bottom end provided with a hook engaged with an edge of the bottom opening of the inserting hole.

3. The pill container as claimed in claim 2, wherein
the lid of each compartment unit has a locking loop formed on and protruding from the inner surface of the lid at an end of the lid opposite the rear wall of the compartment of the compartment unit; and
the locking button on the compartment of each compartment unit has a locking block formed on and protruding from the locking button and selectively engaged with the locking loop on the lid of the compartment unit.

4. The pill container as claimed in claim 3, wherein the locking button of each compartment unit has a connecting segment formed on a bottom end of the locking button and connected integrally with the front wall the compartment to define a gap between the front wall and the compartment.

5. The pill container as claimed in claim 4, wherein
the compartment of each compartment unit further has a pair of pivotal tabs formed on the rear wall of the compartment, and each pivotal tab of the compartment of each compartment unit has a pivotal axle formed on and protruding from the pivotal tab and aligned with the pivotal axle on the other pivotal tab of the compartment; and
the lid of each compartment unit has two pivotal holes defined in the lid and located around the pivotal axles on the pivotal tabs of the compartment of the compartment unit.

6. The pill container as claimed in claim 1, wherein
the lid of each compartment unit has a locking loop formed on and protruding from the inner surface of the lid at an end of the lid opposite the rear wall of the compartment of the compartment unit; and
the locking button on the compartment of each compartment unit has a locking block formed on and protruding from the locking button and selectively engaged with the locking loop on the lid of the compartment unit.

7. The pill container as claimed in claim 6, wherein the locking button of each compartment unit has a connecting segment formed on a bottom end of the locking button and connected integrally with the front wall the compartment to define a gap between the front wall and the compartment.

8. The pill container as claimed in claim 7, wherein
the compartment of each compartment unit further has a pair of pivotal tabs formed on the rear wall of the compartment, and each pivotal tab of the compartment of each compartment unit has a pivotal axle formed on and protruding from the pivotal tab and aligned with the pivotal axle on the other pivotal tab of the compartment; and
the lid of each compartment unit has two pivotal holes defined in the lid and located around the pivotal axles on the pivotal tabs of the compartment of the compartment unit.

9. The pill container as claimed in claim 1, wherein
the compartment of each compartment unit further has a pair of pivotal tabs formed on the rear wall of the compartment, and each pivotal tab of the compartment of each compartment unit has a pivotal axle formed on and protruding from the pivotal tab and aligned with the pivotal axle on the other pivotal tab of the compartment; and
the lid of each compartment unit has two pivotal holes defined in the lid and located around the pivotal axles on the pivotal tabs of the compartment of the compartment unit.
